(19) United States
(12) Patent Application Publication
(10) Pub. No.: US 2026/0322903 A1
(43) Pub. Date: Oct. 15, 2026

(54) FOLDABLE DRIVE APPARATUS AND FOLDABLE SCREEN DEVICE

(71) Applicant: AAC Microtech (Changzhou) Co., Ltd., Changzhou City (CN)

(72) Inventors: Sensen Yang, Changzhou (CN); Junsheng Wang, Changzhou (CN); Haowen Wang, Changzhou (CN)

(21) Appl. No.: 19/307,011

(22) Filed: Aug. 21, 2025

Related U.S. Application Data
(63) Continuation of application No. PCT/CN2025/088314, filed on Apr. 10, 2025.

(51) Int. Cl. H04M 1/02; F16C 11/04

(52) U.S. Cl. CPC H04M 1/022; F16C 11/04; H04M 1/0268

(57) ABSTRACT

Provided are a foldable drive apparatus and a foldable screen device, and the apparatus includes a support frame with an accommodating groove, a guide rail fixedly connected to the support frame, a slider slidably connected to the guide rail, a switch fixedly connected to the slider, two drive motors fixed on opposite sides of the slider, first gears fixed on output ends of the two drive motors, two reducers fixedly connected to the support frame, and second gears fixed on input ends of the two reducers. The drive motors and the reducers are arranged along a sliding direction of the slider, the drive motors are spaced apart from the support frame, and the second gears are meshed with the first gears respectively. The foldable drive apparatus can realize an electric folding mode and a manual folding mode of the foldable screen device, thereby enhancing the user experience.

### CROSS-REFERENCE TO RELATED APPLICATIONS

This application is a continuation of International Application No. PCT/CN2025/088314, filed Apr. 10, 2025, the entire contents of which are incorporated herein by reference.

### TECHNICAL FIELD

The present application relates to the field of folding technologies, in particular to a foldable drive apparatus and a foldable screen device.

### BACKGROUND

Foldable screen devices, such as foldable smartphones, represent a new generation of flexible-display mobile phones capable of bending operations. These devices adopt either single-screen or dual-screen folding configurations. Regardless of whether it is a single-screen folding mobile phone or a double-screen folding mobile phone, both designs aim to fold the mobile phone to facilitate the user's carrying.

The foldable screen device in the related art mainly includes a first folding screen, a second folding screen, a foldable drive apparatus, and a transmission mechanism connected to the foldable drive apparatus. The first folding screen and the second folding screen are rotatably connected to the transmission mechanism. After the foldable drive apparatus is turned on, the first folding screen and the second folding screen are driven to fold through the transmission mechanism.

Although the foldable screen device in the related art can realize the electric folding of the first folding screen and the second folding screen, this purely electric folding method suffers from functional oversimplification that degrades user experience. Furthermore, when the user encounters a situation of insufficient power, the foldable screen device may become unable to fold.

Therefore, it is necessary to provide a new foldable drive apparatus and a foldable screen device to solve the above technical problems.

### SUMMARY

An object of the present application is to provide a new foldable drive apparatus and a foldable screen device to address the issue that the foldable screen devices in the related art using purely electric folding methods are too limited, resulting in a poor user experience, and the foldable screen device becomes unable to fold when users encounter insufficient battery power.

In the first aspect, the present application provides a foldable drive apparatus applied in a foldable screen device, including:
a support frame with an accommodating groove;
a guide rail accommodated within the accommodating groove and fixedly connected to the support frame;
a slider slidably connected to the guide rail and spaced apart from the support frame;
a switch sequentially arranged through the support frame and the guide rail and fixedly connected to the slider;
two drive motors fixed on opposite sides of the slider, respectively;
first gears fixed on output ends of the two drive motors;
two reducers accommodated within the accommodating groove and fixedly connected to the support frame; and
second gears fixed on input ends of the two reducers;
wherein the drive motors and the reducers are arranged along a sliding direction of the slider, and the drive motors are spaced apart from the support frame; the second gears are respectively meshed with the first gears, and the slider and the drive motors are driven to slide relative to the guide rail and the support frame by moving the switch, thereby achieving meshing or disengagement of the first gears and the second gears.

As an improvement, the first gears and the second gears are face gears meshed with each other along their respective axial directions; any end face of one of the first gears and the second gears is provided with an inserting portion protruding outward along its axial direction, and any end face of the other of the first gears and the second gears is provided with a slot arranged through the end face along its axial direction; the inserting portion is inserted into the slot.

As an improvement, a first sleeve with an annular shape is fixedly sleeved around an end of each of the drive motors adjacent to the reducers; a second sleeve with an annular shape is fixedly sleeved around an end of each of the reducers adjacent to the drive motors; an end of the second sleeve adjacent to the first sleeve is extended outwardly along its axial direction to form a an annular snap-fit portion, and the snap-fit portion is inserted into the first sleeve to form a sliding connection with the first sleeve.

As an improvement, a surface of the guide rail facing the support frame is provided with a groove recessed inwardly, and opposite sides of the groove are respectively provided with an arc-shaped limiting groove protruding outwardly; the foldable drive apparatus further comprises an elastic member, which comprises a fixing portion accommodated within the groove and sleeved around the switch, elastic arms extending outward from opposite sides of the fixing portion, and a limiting portion with an arc shape extending outward from an end of each of the elastic arms away from the fixing portion; the switch is arranged through the fixing portion and a bottom of the groove in sequence and is fixedly connected to the slider; when the limiting portion slides to a position close to the limiting groove, the limiting portion slides into the limiting groove under elastic forces of the elastic arms.

As an improvement, the guide rail comprises a base plate fixed to the support frame, a first stacking portion extending outward from a middle region of the base plate away from a surface of the support frame, a second stacking portion extending outward from a portion of the first stacking portion, and extension portions extending outward from opposite sides of the second stacking portion and extending beyond the first stacking portion, wherein the extension portions are spaced apart from the base plate; the slider comprises two sliding plates spaced apart from each other, a connecting plate connected to one end of the two sliding plates, and pressing portions formed by bending and extending ends of the sliding plates away from the connecting plate, wherein sides of the two sliding plates facing each other are each provided with a sliding groove formed by inward concavity; the two extension portions are respectively inserted into the sliding grooves of the two sliding plates, so as to form a sliding connection between the slider and the guide rail; the switch is arranged through the base plate and the first stacking portion and is fixedly connected to the connecting plate; the two drive motors are respectively fixed to sides of the two sliding plates away from the support frame and abutted against the corresponding pressing portions.

As an improvement, a position of the support frame adjacent to the drive motors is provided a snap groove recessed inwardly, the drive motors are spaced apart from a bottom of the snap groove, and a length of the snap groove along the sliding direction of the slider is equal to a length of the drive motor plus a sliding distance of the switch.

As an improvement, the foldable drive apparatus further includes a bracket accommodated within the accommodating groove and fixedly connected to the support frame, wherein two sides of the bracket are each provided with an arc-shaped groove recessed inwardly, an end of each of the reducers away from the drive motors is inserted into the arc-shaped groove, and an output end of each of the reducers is arranged through the bracket and extends along a direction away from the drive motor.

As an improvement, an inner side of the support frame is provided with a support plate protruding outwardly, and the support plate is provided with support grooves formed by recessed inwardly at positions corresponding to the drive motors and the reducers.

As an improvement, the support frame and the guide rail are both provided with a through waist-shaped hole at a position corresponding to the switch, and the switch is sequentially arranged through the waist-shaped hole on the support frame and the waist-shaped hole on the guide rail and forms a fixed connection with the slider.

Secondly, the present application provides a foldable screen device including the aforementioned foldable drive apparatus and a first folding screen and a second folding screen that are rotatably connected to output ends of the two reducers, respectively; wherein the switch is arranged through a connecting position between the first folding screen and the second folding screen; the first folding screen and the second folding screen are electrically opened and closed when the first gears are meshed with the second gears, and the first folding screen and the second folding screen are manually opened and closed when the first gears are separated from the second gears.

Compared with the related art, the foldable drive apparatus of the present application fixes the guide rail and the reducers to the support frame, fixes the drive motor to the slider, and forms a sliding connection between the slider and the guide rail. It also designs a switch that sequentially passes through the support frame and the guide rail and forms a fixed connection with the slider. When applied to a foldable screen device, this foldable drive apparatus not only enables electric folding of the device by the drive motor but also allows manual folding by disengaging the drive motor from the reducer by the switch, thereby diversifying the folding methods of the foldable screen device and enhancing the user experience.

### BRIEF DESCRIPTION OF THE DRAWINGS

In order to more clearly illustrate the technical solutions in the embodiments of the present application, the accompanying drawings that need to be used in the description of the embodiments will be briefly introduced as follows. Obviously, the accompanying drawings in the following description are only some of the embodiments of the present application. For the person of ordinary skill in the field, other accompanying drawings may be obtained based on these drawings without putting forth any creative labor.

FIG. 1 shows a three-dimensional structural schematic diagram of a foldable drive apparatus according to Embodiment one of the present application.

FIG. 2 is a partial exploded view of the foldable drive apparatus according to Embodiment one of the present application.

FIG. 3 is a first exploded view of a partial structure of a drive motor and a gearbox in the foldable drive apparatus according to Embodiment one of the present application.

FIG. 4 is a second exploded view of a partial structure of the drive motor and gearbox in the foldable drive apparatus according to Embodiment one of the present application.

FIG. 5 shows a partially exploded view of a guide rail, a switch, and an elastic member in the foldable drive apparatus according to Embodiment one of the present application.

FIG. 6 shows a front view of the foldable screen device according to Embodiment two of the present application.

FIG. 7 is a back view of the foldable screen device according to Embodiment two of the present application.

FIG. 8 is a schematic structural diagram of the foldable screen device with a portion of structures hidden to expose the foldable drive apparatus according to Embodiment two of the present application.

In the figures, 100, foldable drive apparatus; 1, support frame; 11, snap groove; 12, support plate; 121, support groove; 13, waist-shaped hole; 14, accommodating groove; 2, guide rail; 21, groove; 211, limiting groove; 22, base plate; 23, first stacking portion; 24, second stacking portion; 25, extension portion; 3, slider; 31, sliding plate; 311, sliding groove; 32, connecting plate; 33, pressing portion; 4, switch; 5, drive motor; 51, first sleeve; 52, output end of the drive motor; 6, first gear; 61, inserting portion; 7, gearbox; 71, second sleeve; 711, snap-fit portion; 72, input end of the gearbox; 8, second gear; 81, slot; 9, elastic member; 91, fixing portion; 92, elastic arm; 93, limiting portion; 101, bracket; 1011, arc-shaped groove; 110, circuit board;

200, foldable screen device; 201, first folding screen; and 202, second folding screen.

### DETAILED DESCRIPTION OF THE EMBODIMENTS

The technical solutions of the embodiments of the present application will be described in detail below with reference to the accompanying drawings. It should be noted that the described embodiments are merely some examples of the present application and not all possible embodiments. All other embodiments obtained by ordinary technicians in the field without making creative contributions based on the embodiments of the present application are within the scope of protection of the present application.

### Embodiment One

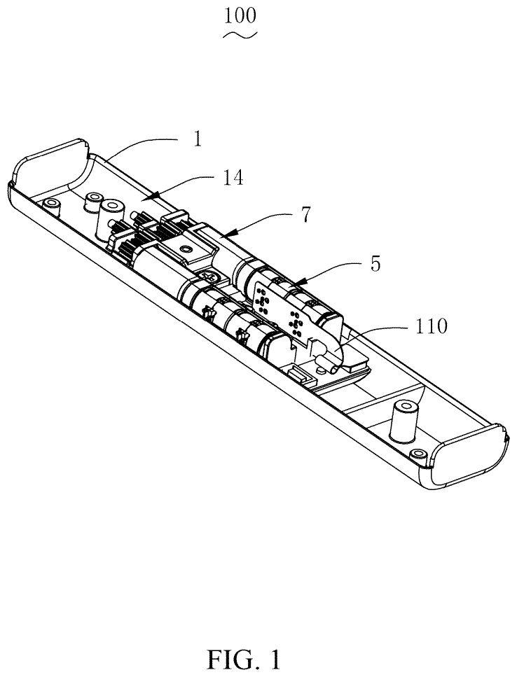

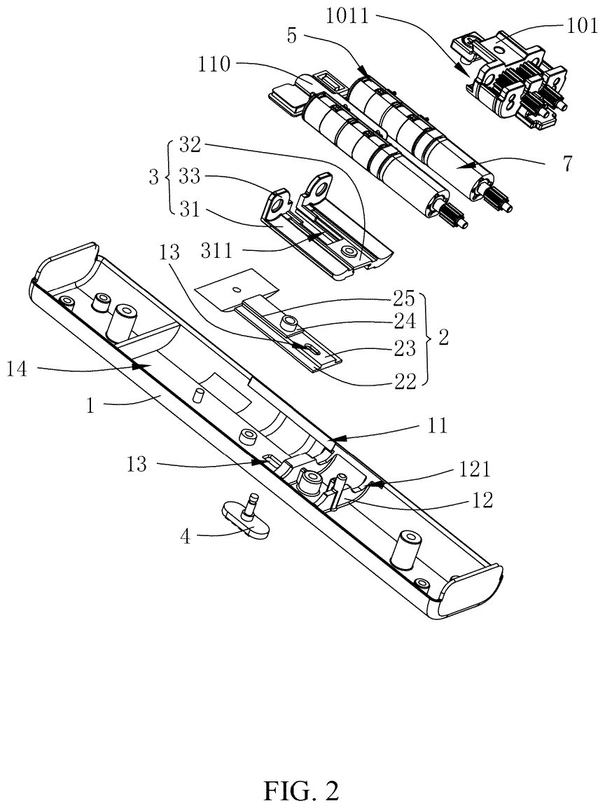

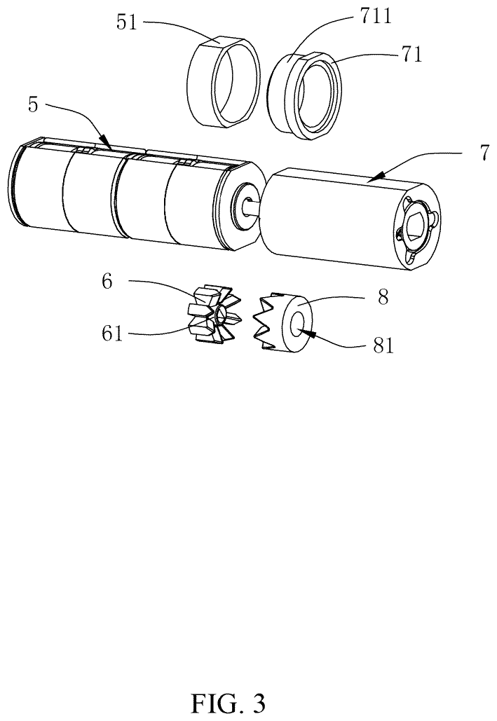

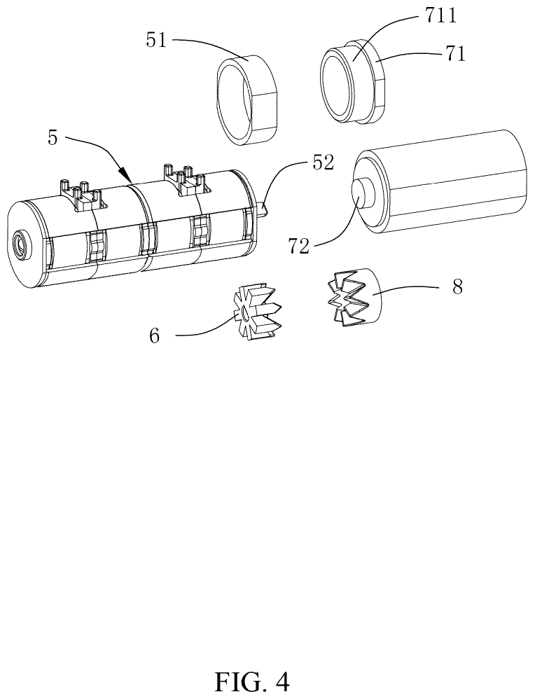

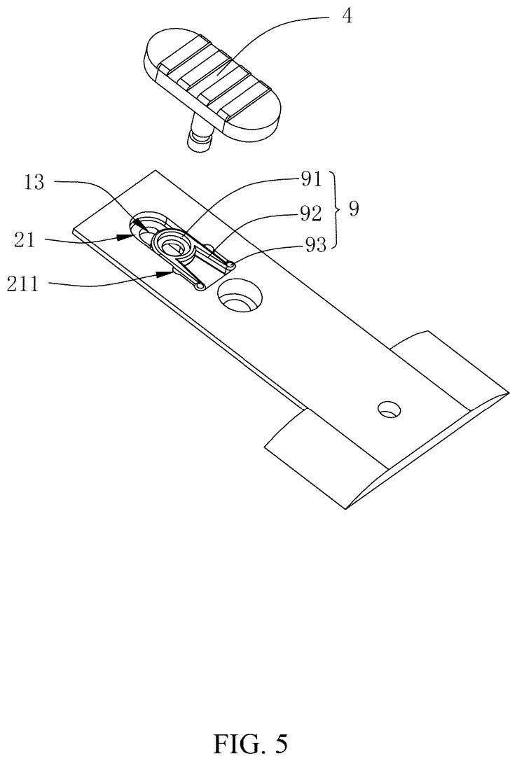

The present application provides a foldable drive apparatus 100, as shown in FIGS. 1 to 5, including a support frame 1 with an accommodating groove 14, a guide rail 2 accommodated within the accommodating groove 14 and fixedly connected to the support frame 1, a slider 3 slidably connected to the guide rail 2 and spaced apart from the support frame 1, a switch 4 sequentially arranged through the support frame 1 and the guide rail 2 and fixedly connected to the slider 3, two drive motors 5 fixed on opposite sides of the slider 3, first gears 6 fixed on the output ends 52 of the two drive motors, two reducers 7 accommodated within the accommodating groove 14 and fixedly connected to the support frame 1, and second gears 8 fixed on the input ends 72 of the two reducers. The drive motors 5 and the reducers 7 are arranged along a sliding direction of the slider, and the drive motors 5 are spaced apart from the support frame 1. The second gears 8 are respectively meshed with the first gears 6, and the slider 3 and the drive motors 5 are driven to slide relative to the guide rail 2 and the support frame 1 by moving the switch 4, thereby achieving meshing or disengagement between the first gears 6 and the second gears 8.

The foldable drive apparatus 100 is applied to foldable screen devices, such as folding mobile phones, to achieve the folding of the foldable screen device.

A position of the support frame 1 adjacent to the drive motor is provided with a snap groove 11 inwardly recessed, and the drive motors 5 are spaced apart from the bottom of the snap groove 11. The length of the snap groove 11 along the sliding direction of the slider 3 is equal to the length of the drive motor 5 plus the sliding distance of the switch 4. This design not only achieves the spaced arrangement between the drive motor 5 and the support frame 1 but also limits the sliding distance of the slider 3 via the length of the snap groove 11.

An inner side of the support frame 1 is provided with an support plate 12 protruding outwardly, which is provided with support grooves 121 formed by inwardly concave portions corresponding to the positions of the drive motors 5 and the reducers 7. In this embodiment, there are two support plates 12, one for supporting the drive motors 5, and the other for supporting the reducers 7. This design facilitates the fixation of the drive motors 5 and the reducers 7, and allows the input end 72 of each reducer to be conveniently connected to the output end 52 of each drive motor.

The support frame 1 and the guide rail 2 are both provided with a through waist-shaped holes 13 at a position corresponding to the switch 4, and the switch 4 is sequentially arranged through the waist-shaped hole 13 on the support frame 1 and the waist-shaped hole 13 on the guide rail 2 and forms a fixed connection with the slider 3. The length of the waist-shaped holes 13 is equal to the sliding distance of the slider 3. Accordingly, the switch 4 is T-shaped to facilitate passing through the support frame 1 and the guide rail 2, and has a portion exposed outside the support frame 1. This design facilitates the formation of sliding connections between the switch 4 and both the support frame 1 and the guide rail 2.

A surface of the guide rail 2 facing the support frame 1 is provided with a groove 21 recessed inwardly, and the opposite sides of groove 21 are each provided with arc-shaped limiting grooves 211 protruding outwardly. The foldable drive apparatus 100 further includes an elastic member 9, which includes a fixing portion 91 accommodated within the groove 21 and sleeved around the switch 4, elastic arms 92 extending outward from the opposite sides of the fixing portion 91, and a limiting portion 93 with an arc shape extending outward from the end of each elastic arms 92 away from the fixing portion 91. The switch 4 is arranged through the fixing portion 91 and the bottom of the groove 21 in sequence and is fixedly connected to the slider 3. When the limiting portion 93 slides to a position close to limiting groove 211, the limiting portion 93 slides into the limiting groove 211 under the elastic force of the elastic arms 92. This design allows the position of the slider 3 to be limited by the limiting action of the limiting portion 93 sliding into the limiting groove 211 when the switch 4 slides, thereby preventing the drive motor 5 on the slider 3 from misaligning during operation and ensuring normal use of electric or manual folding.

The guide rail 2 includes a base plate 22 fixed to the support frame 1, a first stacking portion 23 protruding and extending from the middle region of the base plate 22 away from the surface of the support frame 1, a second stacking portion 24 protruding and extending from a portion of the first stacking portion 23, and extension portions 25 protruding and extending outward from the opposite sides of the second stacking portion 24 and extending beyond the first stacking portion 23. The extension portions 25 are spaced apart from the base plate 22. The slider 3 includes two sliding plates 31 spaced apart from each other, a connecting plate 32 connecting one end of the two sliding plates 31, and pressing portions 33 formed by bending and extending the ends of the sliding plates 31 away from the connecting plate 32. The sides of the two sliding plates 31 facing each other are each provided with a sliding groove 311 formed by an inward concavity. The two extension portions 25 are respectively inserted into the sliding grooves 311 of the two sliding plates 31, thereby forming a sliding connection between the slider 3 and the guide rail 2. The switch 4 is arranged through the base plate 22 and the first stacking portion 23 and is fixedly connected to the connecting plate 32. The two drive motors 5 are respectively fixed to the sides of the two sliding plates 31 away from the support frame 1 and abut against the corresponding pressing portions 33. The waist-shaped holes 13 on the guide rail 2 are sequentially arranged through the corresponding positions of the base plate 22 and the first stacking portion 23. This design enables the sliding connection between the slider 3 and the guide rail 2 within the narrow accommodating groove 14 of the support frame 1, thereby achieving a compact structure for the foldable drive apparatus 100, making it suitable for the limited space of foldable screen devices.

The first gear 6 and the second gear 8 are face gears meshed with each other along their respective axial directions. Any end face of one of the first gears 6 and the second gears 8 is provided with an inserting portion 61 protruding outward along its axial direction on any of its end faces, and any end face of the other of the first gears 6 and the second gears 8 is provided with a slot 81 arranged through the end face along its axial direction. The inserting portion 61 is inserted into the slot 81. By designing the first gears 6 and the second gears 8 as face gears and incorporating matching inserting portions 61 and slots 81 on the first gear 6 and the second gear 8, it is ensured that the first gears 6 of the drive motors 5 and the second gears 8 of the reducers 7 can engage and disengage when connected or disconnected, thereby ensuring the normal rotation of the foldable drive apparatus 100. In this embodiment, the inserting portion 61 is provided on the first gear 6, and the slot 81 is provided on the second gear 8.

A first sleeve 51 with an annular shape is fixedly sleeved around the end of each drive motor 5 adjacent to the reducer 7, and a second sleeve 71 with an annular shape is fixedly sleeved around the end of each reducer 7 adjacent to the drive motor 5. An end of the second sleeve 71 adjacent to the first sleeve 51 is extended outwardly along its axial direction to form an annular snap-fit portion 711. The snap-fit portion 711 is inserted into the first sleeve 51 and forms a sliding connection with the first sleeve 51. This design further ensures that the first gears 6 of the drive motors 5 and the second gears 8 of the reducers 7 can engage and disengage when connected or separated, ensuring the normal rotation of the foldable drive apparatus 100.

The foldable drive apparatus 100 further includes a bracket 101 accommodated within the accommodating groove 14 and fixedly connected to the support frame 1. Two sides of the support frame 101 are each provided with an arc-shaped groove 1011 recessed inwardly. The end of the reducer 7 away from the drive motor 5 is inserted into the arc-shaped groove 1011, and the output end of the reducer 7 is arranged through the support frame 101 and extends along the direction away from the drive motor 5. This design facilitates the secure mounting of the reducer 7, preventing it from vibrating or disengaging during operation of the foldable drive apparatus 100.

The foldable drive apparatus 100 further includes a circuit board 110 electrically connected to the drive motor 5.

In the foldable drive apparatus 100 of this embodiment, electric folding operation is maintained when the first gear 6 and second gear 8 remain engaged. To switch to manual folding mode, actuating the toggle switch 4 disengages the first gears 6 of the motors from the second gears 8 of the reducers, while simultaneously reducing the self-locking torque of the reducers to enable manual folding operation. If it is necessary to switch back to electric folding, the switch 4 can be actuated again to re-engage the first gears 6 of the drive motors 5 with the second gears 8 of the reducers 7, enabling normal electric folding. In the foldable drive apparatus 100 of this embodiment, the two folding modes—electric folding and manual folding—do not interfere with each other.

In foldable screen devices based on electric drive concepts in the related art, due to constraints on the length, width, and height of the internal space of the foldable screen device, high-ratio reducers are often designed to increase the torque required for folding hinges. Such structures have a high self-locking force, making manual folding difficult. In contrast, this embodiment achieves a sliding design in a confined space by connecting the slider 3 to the guide rail 2 by a sliding connection and mounting the drive motor 5 on the slider 3. This allows the drive motor 5 to be separated from the reducer 7, enabling manual folding.

In the related art, the connection between the motor and the reducer in the foldable screen device typically uses flat pins or keys for transmission. During the switching process between electric and manual folding, such structures cannot ensure that the flat pins or keys can be realigned after separation and manual folding. In contrast, this embodiment uses a design with face gears to address the issues of inability to realign and engage in confined spaces.

The foldable drive apparatus 100 in this embodiment is designed based on the dimensions of the foldable screen device, reasonably allocating space for smaller radial width, axial length, and longitudinal height. It features a compact structure, high space utilization, high component integration, and reliability, and enables switching between electric and manual folding, making it suitable for a wider range of applications.

Compared with the related art, the foldable drive apparatus 100 in this embodiment fixes the guide rail 2 and the reducers 3 to the support frame 1, fixes the drive motor 5 to the slider 3, and forms a sliding connection between the slider 3 and the guide rail 2. It also designs a switch 4 that sequentially passes through the support frame 1 and the guide rail 2 and forms a fixed connection with the slider 3. When applied to a foldable screen device, this foldable drive apparatus 100 not only enables electric folding of the device by the drive motor 5 but also allows manual folding by disengaging the drive motor 5 from the reducer 7 by the switch 4, thereby diversifying the folding methods of the foldable screen device and enhancing the user experience. Additionally, by adding a manual folding option, the device can be manually folded even when the battery is low, improving its convenience.

### Embodiment Two

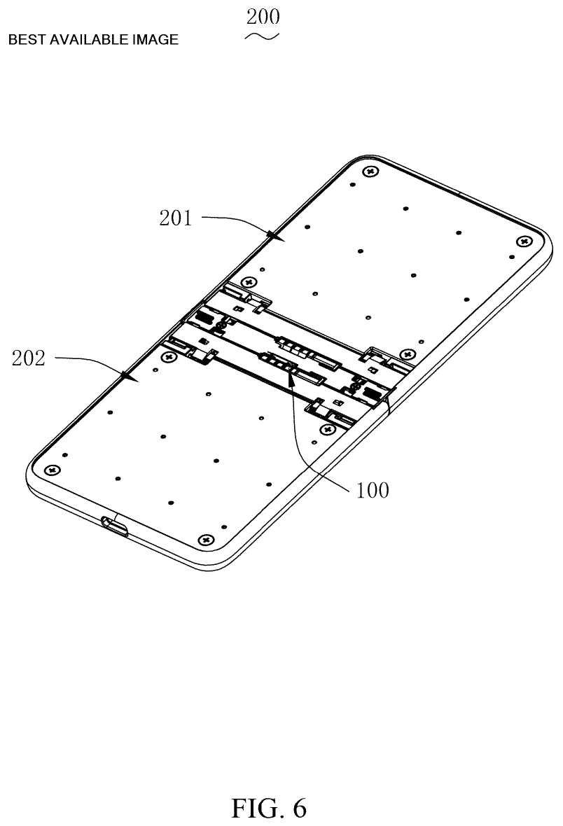

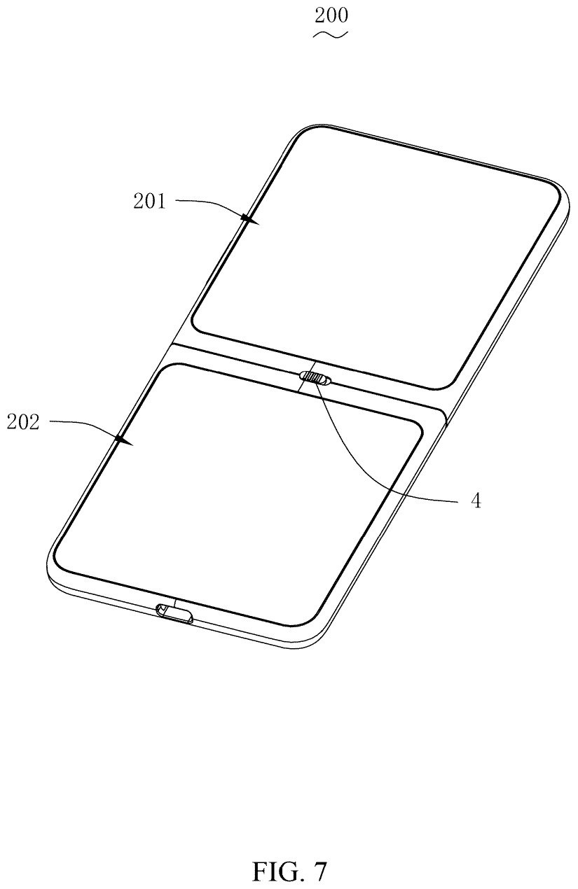

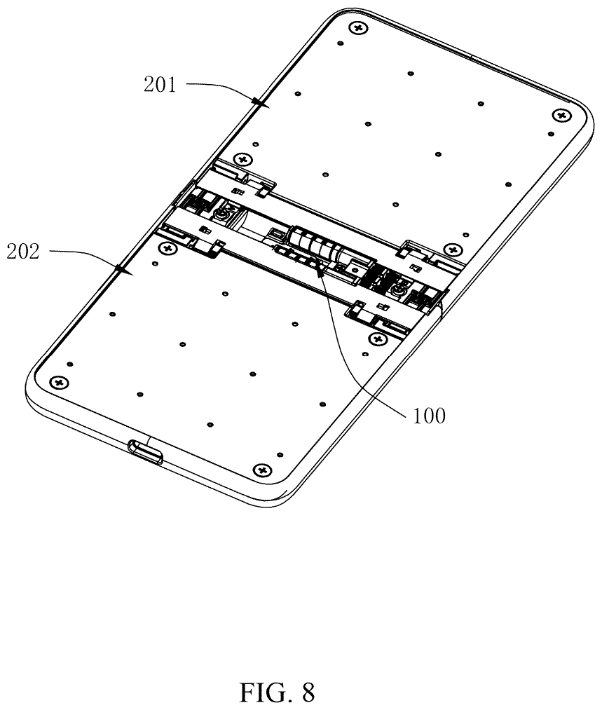

This embodiment provides a foldable screen device 200, as shown in FIGS. 6 to 8, including a foldable drive apparatus 100 as in Embodiment one above, and a first folding screen 201 and a second folding screen 202 that are rotatably connected to the output ends of the two reducers 7, respectively. The switch 4 is arranged through a connecting position between the first folding screen 201 and the second folding screen 202. The first folding screen 201 and the second folding screen 202 are electrically opened and closed when the first gears 6 are meshed with the second gears 8, and the first folding screen 201 and the second folding screen 202 are manually opened and closed when the first gears 6 are separated from the second gears 8.

The electric opening and closing of the first folding screen 201 and the second folding screen 202 is achieved by clicking on a specific area of the entire screen, which corresponds to the specific area being a switch that activates the drive motor 5.

The switch 4 passes through the first folding screen 201 and the second folding screen 202 in two ways: in the first case, the switch 4 is exposed to the first folding screen 201 and the second folding screen 202, that is, the outer face of the switch 4 protrudes more outwards relative to the outer faces of the first folding screen 201 and the second folding screen 202. In the second case, the outer face of the switch 4 is located at the same level as the outer faces of the first folding screen 201 and the second folding screen 202.

Since the foldable screen device 200 in this embodiment includes the foldable drive apparatus 100 in Embodiment one as above, it can also achieve the technical effect achieved by the foldable drive apparatus 100 in Embodiment one as above, which will not be repeated herein.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A foldable drive apparatus applied in a foldable screen device, comprising:
a support frame with an accommodating groove;
a guide rail accommodated within the accommodating groove and fixedly connected to the support frame;
a slider slidably connected to the guide rail and spaced apart from the support frame;
a switch sequentially arranged through the support frame and the guide rail and fixedly connected to the slider;
two drive motors fixed on opposite sides of the slider, respectively;
first gears fixed on output ends of the two drive motors;
two reducers accommodated within the accommodating groove and fixedly connected to the support frame; and
second gears fixed on input ends of the two reducers;
wherein the drive motors and the reducers are arranged along a sliding direction of the slider, and the drive motors are spaced apart from the support frame; the second gears are respectively meshed with the first gears, and the slider and the drive motors are driven to slide relative to the guide rail and the support frame by moving the switch, thereby achieving meshing or disengagement of the first gears and the second gears.

2. The foldable drive apparatus of claim 1, wherein the first gears and the second gears are face gears meshed with each other along their respective axial directions; any end face of one of the first gears and the second gears is provided with an inserting portion protruding outward along its axial direction, and any end face of the other of the first gears and the second gears is provided with a slot arranged through the end face along its axial direction; the inserting portion is inserted into the slot.

3. The foldable drive apparatus of claim 1, wherein a first sleeve with an annular shape is fixedly sleeved around an end of each of the drive motors adjacent to the reducers; a second sleeve with an annular shape is fixedly sleeved around an end of each of the reducers adjacent to the drive motors; an end of the second sleeve adjacent to the first sleeve is extended outwardly along its axial direction to form a an annular snap-fit portion, and the snap-fit portion is inserted into the first sleeve to form a sliding connection with the first sleeve.

4. The foldable drive apparatus of claim 1, wherein a surface of the guide rail facing the support frame is provided with a groove recessed inwardly, and opposite sides of the groove are respectively provided with an arc-shaped limiting groove protruding outwardly; the foldable drive apparatus further comprises an elastic member, which comprises a fixing portion accommodated within the groove and sleeved around the switch, elastic arms extending outward from opposite sides of the fixing portion, and a limiting portion with an arc shape extending outward from an end of each of the elastic arms away from the fixing portion; the switch is arranged through the fixing portion and a bottom of the groove in sequence and is fixedly connected to the slider; when the limiting portion slides to a position close to the limiting groove, the limiting portion slides into the limiting groove under elastic forces of the elastic arms.

5. The foldable drive apparatus of claim 1, wherein the guide rail comprises a base plate fixed to the support frame, a first stacking portion extending outward from a middle region of the base plate away from a surface of the support frame, a second stacking portion extending outward from a portion of the first stacking portion, and extension portions extending outward from opposite sides of the second stacking portion and extending beyond the first stacking portion, wherein the extension portions are spaced apart from the base plate; the slider comprises two sliding plates spaced apart from each other, a connecting plate connected to one end of the two sliding plates, and pressing portions formed by bending and extending ends of the sliding plates away from the connecting plate, wherein sides of the two sliding plates facing each other are each provided with a sliding groove formed by inward concavity; the two extension portions are respectively inserted into the sliding grooves of the two sliding plates, so as to form a sliding connection between the slider and the guide rail; the switch is arranged through the base plate and the first stacking portion and is fixedly connected to the connecting plate; the two drive motors are respectively fixed to sides of the two sliding plates away from the support frame and abutted against the corresponding pressing portions.

6. The foldable drive apparatus of claim 1, wherein a position of the support frame adjacent to the drive motors is provided a snap groove recessed inwardly, the drive motors are spaced apart from a bottom of the snap groove, and a length of the snap groove along the sliding direction of the slider is equal to a length of the drive motor plus a sliding distance of the switch.

7. The foldable drive apparatus of claim 1, further comprising a bracket accommodated within the accommodating groove and fixedly connected to the support frame, wherein two sides of the bracket are each provided with an arc-shaped groove recessed inwardly, an end of each of the reducers away from the drive motors is inserted into the arc-shaped groove, and an output end of each of the reducers is arranged through the bracket and extends along a direction away from the drive motor.

8. The foldable drive apparatus of claim 1, wherein an inner side of the support frame is provided with a support plate protruding outwardly, and the support plate is provided with support grooves formed by recessed inwardly at positions corresponding to the drive motors and the reducers.

9. The foldable drive apparatus of claim 1, wherein the support frame and the guide rail are both provided with a through waist-shaped hole at a position corresponding to the switch, and the switch is sequentially arranged through the waist-shaped hole on the support frame and the waist-shaped hole on the guide rail and forms a fixed connection with the slider.

10. A foldable screen device, comprising:
the foldable drive apparatus of claim 1; and
a first folding screen and a second folding screen that are rotatably connected to output ends of the two reducers, respectively;
wherein the switch is arranged through a connecting position between the first folding screen and the second folding screen; the first folding screen and the second folding screen are electrically opened and closed when the first gears are meshed with the second gears, and the first folding screen and the second folding screen are manually opened and closed when the first gears are separated from the second gears.
